(19) United States
(12) Patent Application Publication
(10) Pub. No.: US 2015/0224491 A1
(43) Pub. Date: Aug. 13, 2015

(54) CATALYST CARRIER FOR PURIFICATION OF EXHAUST GAS, METHOD FOR PREPARING THE SAME, AND CATALYST FOR PURIFICATION OF EXHAUST GAS

(71) Applicants: Hyundai Motor Company, Seoul (KR); Kia Motors Corporation, Seoul (KR); Chung-Ang University Industry Academic Cooperation Foundation, Seoul (KR)

(72) Inventors: Hyokyung LEE, Anyang-si (KR); Jin Woo CHOUNG, Suwon-si (KR); Jonghwi LEE, Seoul (KR); Byoung Soo KIM, Seoul (KR)

(73) Assignees: Hyundai Motor Company, Seoul (KR); Kia Motors Corporation, Seoul (KR); Chung-Ang University Industry Academic Cooperation Foundation, Seoul (KR)

(21) Appl. No.: 14/485,298

(22) Filed: Sep. 12, 2014

(30) Foreign Application Priority Data
Feb. 11, 2014 (KR) 10-2014-0015625

(51) Int. Cl. B01J 37/02; B01J 21/12; B01J 35/04; B01J 21/04

(52) U.S. Cl. CPC B01J 37/0219; B01J 21/04; B01J 21/12; B01J 35/04

(57) ABSTRACT

A catalyst carrier for purification of exhaust gas, may include a substrate having a plurality of cell paths partitioned by a cell barrier rib and a ceramic coating layer positioned on the inside surface of the cell path, where the ceramic coating layer has a porous lamellar structure arranged in an exhaust gas flow direction, and a method for preparing the same.

### CROSS-REFERENCE TO RELATED APPLICATION

The present application claims priority to Korean Patent Application No. 10-2014-0015625 filed Feb. 11, 2014, the entire contents of which is incorporated herein by this reference.

### BACKGROUND OF THE INVENTION

1. Field of the Invention

This disclosure relates to a catalyst carrier for purification of exhaust gas, a method for preparing the same, and a catalyst for purification of exhaust gas.

2. Description of Related Art

Hazardous materials in vehicle exhaust gas include unburned HC, CO, and nitrogen oxide (NOₓ) produced by high temperature combustion. As all vehicles driven by a gasoline engine or a diesel engine produce exhaust gas including hazardous materials. Due to the number of vehicles increasing every year, many countries in the world strictly regulate exhaust gas quantity and also reinforce fuel efficiency criteria. Accordingly, all vehicles require a device for suppressing the generation of the hazardous materials or purifying the same. A vehicle catalyst is called a 3-way catalyst since it oxidizes CO and HC to be converted into carbon dioxide and water, and simultaneously reduces NOₓ to be converted into non-hazardous nitrogen and oxygen. The after-treatment catalyst for purifying the vehicle exhaust gas is prepared by coating a catalyst component of an oxide and a noble metal onto the porous honeycomb, and representative methods of preparing the coating layer may include a hydrothermal synthesizing method, a wash coating method, and the like.

The hydrothermal synthesizing method is a direct synthesizing method through seeded growth or vapor phase synthesis, and has merits of having strong adherence to the substrate. However, the resultant thereof is prepared by a complicated process and has an extremely dense structure, so only intercrystalline pores exist to limit material diffusion.

The wash coating process is a representative method of preparing the after treatment catalyst coating layer for purifying vehicle exhaust gas, and includes immersing the porous honeycomb into a slurry, air spraying for removing the excess slurry, and drying and firing the same. In this case, a binder is usually used to improve the adherence with a substrate, the ready-made catalyst is easily coated in a relatively simple process, and the obtained structure has characteristics of easily diffusing materials so as to contact the resultant with the catalyst.

Techniques using the wash coating include: using a catalyst for purification of exhaust gas including a double layer of a middle layer including a wash coat material and a catalyst layer positioned on the middle layer and mixed with a wash coat material and a zeolite catalyst (KR 10-0213818); using a catalyst for purification of exhaust gas including a HC adsorption layer, a 3-way catalyst layer positioned on the HC adsorption layer, and a catalyst layer integratedly coated with a CO low temperate oxidization layer between the HC adsorption layer and the 3-way catalyst layer to improve low temperature activity (KR 2011-0055024); a technique of improving durability by coating a catalyst including K₂O after providing a carrier surface with a SiO₂ thin layer to prevent carrier cracks, thus preventing breakage of the carrier structure due to potassium (KR 2003-0056792); and so on.

However, the conventional arts including only simple evaporation processes hardly controls the porosity and the morphology in order to decrease the diffusion distance between reactants.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a catalyst carrier for purification of exhaust gas having good porosity and a good pore shape for material diffusion.

In one aspect of the present invention, a catalyst carrier for purification of exhaust gas, may include a substrate including a plurality of cell paths partitioned by a cell barrier rib; and a ceramic coating layer positioned on an inside surface of the cell paths, wherein the ceramic coating layer includes a porous lamellar structure arranged in an exhaust gas flow direction.

The ceramic coating layer may have an average pore length of approximately 2 μm to approximately 25 μm in a short axis.

The ceramic coating layer may have an average pore length of approximately 0.1 mm to approximately 20 mm in a long axis.

The ceramic coating layer may have an average wall thickness between pores of approximately 0.5 μm to approximately 20 μm.

The ceramic coating layer may include alumina, silica, titania, zirconia, silica-alumina, alumina-zirconia, alumina-titania, silica-titania, silica-zirconia, titania-zirconia, or a combination thereof.

The substrate may include cordierite, mordenite, mullite, α-alumina, β-alumina, γ-alumina, aluminosilicate, spinel, magnesium silicate, titania, zirconia, ceria, silica, an iron-chromium alloy, stainless steel, or a combination thereof.

In another aspect of the present invention, a method of preparing a catalyst carrier for purification of exhaust gas, may include preparing a substrate including a plurality of cell paths partitioned by a cell barrier rib and a ceramic slurry, immersing the substrate into the ceramic slurry to coat the substrate with the ceramic slurry, removing excess ceramic slurry, freezing the ceramic slurry coating layer formed on the substrate in one direction by providing a temperature gradient in a vertical direction to the substrate, removing solvent crystals from the ceramic slurry coating layer frozen in one direction, and heat-treating the ceramic slurry coating layer.

The substrate may include cordierite, mordenite, mullite, α-alumina, β-alumina, γ-alumina, aluminosilicate, spinel, magnesium silicate, titania, zirconia, ceria, silica, iron-chromium alloy, stainless steel, or a combination thereof.

The ceramic slurry may include alumina, silica, titania, zirconia, silica-alumina, alumina-zirconia, alumina-titania, silica-titania, silica-zirconia, titania-zirconia, or a combination thereof.

An amount of ceramic in the ceramic slurry is approximately 1 wt % to approximately 40 wt % based on a total weight of the ceramic slurry.

An amount of ceramic in the ceramic slurry is approximately 10 wt % to 35 wt % based on the total weight of the ceramic slurry.

The ceramic slurry may have viscosity of approximately 9.5 cP to approximately 50 cP.

The ceramic slurry may have viscosity of approximately 25 cP to approximately 45 cP.

The removing of the excess ceramic slurry is performed by air knifing or vacuum suction, and the air knifing or the vacuum suction is performed with a pressure of approximately 20 kg/cm² to approximately 50 kg/cm².

The freezing of the ceramic slurry coating layer in one direction is performed by directly flowing liquid nitrogen onto the substrate in a direction of flow of the exhaust gas, or positioning the substrate vertically on a cooling substrate to be frozen by the liquid nitrogen.

The temperature gradient is provided in a range from approximately −100° C. to—approximately 20° C.

The preparing of the ceramic slurry may further include adding an additive selected from a binder, a dispersing agent, an acid solution, or a combination thereof.

The additive is mixed at approximately 0.1 parts to approximately 10 parts by weight based on 100 parts by weight of ceramic in the ceramic slurry.

The removing of the solvent crystals is performed by lyophilization or etching.

In another aspect of the present invention, a catalyst for purification of the exhaust gas including the catalyst carrier for purification of the exhaust gas and a catalyst.

The present invention may provide a catalyst carrier for purification of exhaust gas having good porosity and a good pore shape for material diffusion, a method of preparing a catalyst carrier for purification of exhaust gas including directional cooling crystallization, and a catalyst for purification of exhaust gas including the same.

Other aspects and preferred embodiments of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic illustration of a method of preparing a catalyst carrier for purification of exhaust gas according to an exemplary embodiment of the present invention.

FIG. 2 is a scanning electron microscopic photograph showing a cross-sectional surface of a catalyst carrier for purification of exhaust gas obtained by the conventional preparing method.

FIGS. 3 to 5 are scanning electron microscopic photographs showing the surface of a coating layer of the catalyst carrier for purification of exhaust gas shown in FIG. 2.

FIGS. 6 to 9 are scanning electron microscopic photographs showing the surface of a coating layer of a catalyst carrier for purification of exhaust gas according to an exemplary embodiment of the present invention.

FIGS. 10 to 12 are scanning electron microscopic photographs showing the surface of a coating layer catalyst carrier for purification of exhaust gas corresponding to a slurry concentration according to an exemplary embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described with reference to the accompanying drawings so that those skilled in the Field of the Invention to which the present invention pertains may carry out the exemplary embodiment.

In one aspect of the present invention, a catalyst carrier for purification of exhaust gas may include a substrate including a plurality of cell paths partitioned by a cell barrier and a ceramic coating layer positioned on the inside surface of the cell paths, where the ceramic coating layer may have a porous lamellar structure arranged in a direction of flow of the exhaust gas.

In another aspect of the present invention, the catalyst for purification of exhaust gas may include the catalyst carrier for purification of exhaust gas and a catalyst.

Substrate: The substrate including a plurality of cell paths partitioned by a cell barrier rib may have a honeycomb structure or a monolithic structure.

The substrate may have a straight flowing structure having a honeycomb-shaped path, a foam structure, a pellet structure, or the like. The material thereof may include heat resistant ceramics (such as cordierite), metals, or the like which are conventionally used as a catalyst for purification of exhaust gas. For example, the material may include cordierite, mordenite, mullite, α-alumina, β-alumina, γ-alumina, aluminosilicate, spinel, magnesium silicate, titania, zirconia, ceria, silica, an iron-chromium alloy, stainless steel, or a combination thereof, and it may have a porous shape such as honeycomb formed by a material such as cordierite, in the view of dispersing and supporting a catalyst component.

For example, the honeycomb structure may be fabricated by coating honeycomb having a monolithic structure with a metal supported fire-resistant inorganic side product, and a rare earth element oxide produced by supporting a platinum-based metal, a lanthanum-based metal, and another active metal on alumina and zeolite, zirconia yttria titania.

Ceramic coating layer: The ceramic coating layer positioned on the inside surface of the cell path may be a porous lamellar structure arranged in a direction of flow of exhaust gas.

The lamellar structure generally refers to a structure in which thin-sheet minute crystals are regularly arranged. In an aspect of the present invention, the lamellar structure is referred to as a state that oval pores having an elongated length in a direction of flow of exhaust gas on the ceramic coating layer according to directional cooling crystallization are formed, resultantly arranging the ceramic particles for a coating layer as minute crystals having a thin sheet shape.

The ceramic coating layer supporting a catalyst carrier for purification of exhaust gas may have a lamellar structure, so particle density per unit volume of catalysts added or adsorbed into the ceramic coating layer is increased to improve the reactivity of the catalyst with pollutants passing through the carrier.

The ceramic coating layer may have an average pore length of about 2 (micrometers) um to about 25 μm in a short axis, and may have a long axis length similar to a height of the substrate. Specifically, the long axis length may range from about 0.1 (millimeters) mm to about 20 mm. This is because the solvent crystals may be grown as high as the height of the substrate in a direction of flow of exhaust gas.

In addition, the average wall thickness between pores may range from about 0.5 μm to about 20 μm, more specifically about 1 μm to about 5 μm.

When the average pore length and the average wall thickness between pores are within the range, the possibility of contacting the carrier to the catalyst may be maximized, and the diffusion limitation of the reactant may be decreased, so as to provide good catalyst activation.

Catalyst: The catalyst used in the present invention may include any catalysts as long as they are used in the technical field of the present invention, without limitation.

Generally, the catalyst may include at least one kind of element selected from the group consisting of platinum, palladium, rhodium, copper, silver, gold, iron, zinc, manganese, nickel, cobalt, vanadium, molybdenum, an alkaline earth element, and a rare earth element, and for example, it may include a 3-way catalyst capable of simultaneously removing hazardous materials, for example, carbon monoxide (CO), hydrocarbons (HC), nitrogen oxides (NOₓ), or the like from exhaust gas by oxidizing or reducing the hazardous materials to non-hazardous safe materials of carbon dioxide, water, nitrogen, or the like. The 3-way catalyst may be prepared mainly with an expensive noble metal such as platinum, palladium, rhodium, or the like.

Besides the catalyst including a main component of the noble metal, an assist catalyst of ceria (CeO₂) and the like which is effective in removing soluble organic components may also be used.

For example, the catalyst may be added together when providing a ceramic slurry, so as to be included in the ceramic coating layer of catalyst carrier for purification of exhaust gas; or a separate catalyst is adsorbed after providing the ceramic coating layer of the catalyst carrier for purification of exhaust gas, so as to be included in the coating layer.

Hereinafter, the method of preparing a catalyst carrier for purification of exhaust gas according to an exemplary embodiment of the present invention is described.

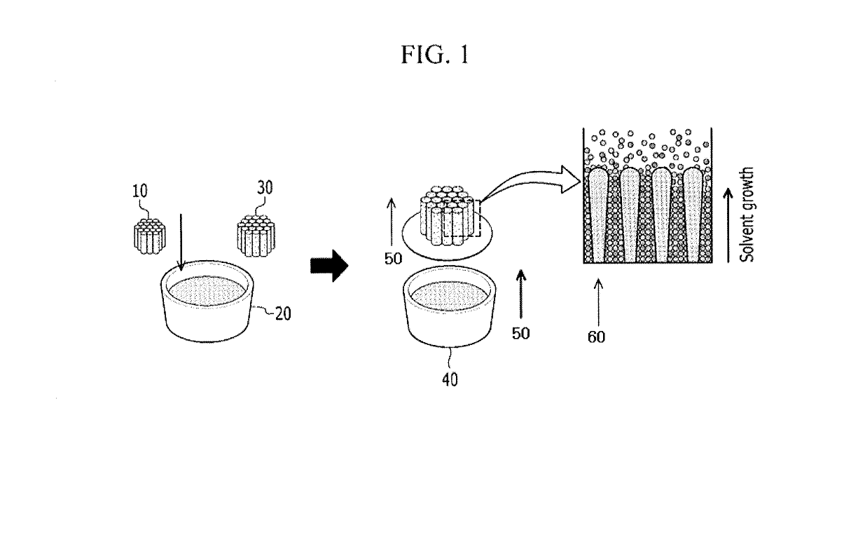

FIG. 1 schematically shows a method of preparing the catalyst carrier for purification of exhaust gas according to one embodiment of the present invention.

The method of preparing a catalyst carrier for purification of exhaust gas according to the present invention may include preparing a substrate 10 including a plurality of cell paths partitioned by a cell barrier rib and a ceramic slurry 20, immersing the substrate into the ceramic slurry to coat the substrate with the ceramic slurry, removing excess ceramic slurry, providing a temperature gradient 50 in a direction perpendicular to the substrate to freeze the ceramic slurry coating layer formed on the inside surface of the cell path in one direction, removing solvent crystals 60 from the ceramic slurry coating layer frozen in one direction; and heat-treating the ceramic slurry coating layer.

The substrate including a plurality of cell paths partitioned by a cell barrier rib is shown to have a honeycomb structure, but may have any structure as long as it is conventionally used as a catalyst for purification of exhaust gas having a structure like honeycomb paths. The substrate having the honeycomb structure may be prepared from a material selected from cordierite, mordenite, mullite, α-alumina, β-alumina, γ-alumina, aluminosilicate, spinel, magnesium silicate, titania, zirconia, ceria, silica, an iron-chromium alloy, stainless steel, or a combination thereof.

The ceramic slurry 20 may be prepared by mixing at least one selected from alumina, silica, titania, zirconia, silica-alumina, alumina-zirconia, alumina-titania, silica-titania, silica-zirconia, titania-zirconia, or a combination thereof with water or an organic solvent, for example acetone, acetonitrile, acetaldehyde, acetic acid, acetophenone, acetylchloride, acrylonitrile, aniline, benzyl alcohol, 1-butanol, n-butylacetate, cyclohexanol, cyclohexanone, 1,2-dibromoethane, diethylketone, N,N-dimethylacetamide, N,N-dimethylformamide, dimethylsulfoxide, 1,4-dioxane, ethanol, ethyl acetate, ethyl formate, formic acid, glycerol, hexamethyl phosphoamide, methyl acetate, methyl ethyl ketone, methyl isobutyl ketone, N-methyl-2-pyrrolidone, nitrobenzene, nitromethane, 1-propanol, propylene-1,2-carbonate, tetrahydrofuran, tetramethylurea, triethylphosphate, trimethyl phosphate, ethylene diamine, and the like, and milling the resultant at room temperature for about 3 to about 24 hours.

The ceramic content in the ceramic slurry 20 may range from about 1 weight (wt) % to about 40 wt %, specifically about 10 wt % to about 35 wt %, based on total weight of the ceramic slurry 20. When the ceramic content is within the range, the viscosity and the concentration of the ceramic slurry 20 may be controlled to provide the ceramic slurry 20 with the appropriate-shaped pore length and wall thickness between pores, so the lamella structure optimized for the catalyst activation may be obtained.

The ceramic slurry 20 may be specifically prepared from at least one selected from alumina, silica, titania, zirconia, silica-alumina, alumina-zirconia, alumina-titania, silica-titania, silica-zirconia, titania-zirconia, and a combination thereof.

In order to improve the adherence of the ceramic coating layer and to control the viscosity and concentration of the ceramic slurry 20, an additive selected from a binder, a dispersing agent, an acid solution, or a combination thereof may be further added.

The additive may be added at about 0.1 to about 10 parts by weight based on 100 parts by weight of ceramic in the ceramic slurry 20.

For example, when the acid solution is added as an additive, the ceramic slurry 20 may be adjusted to have a measurement of acidity (pH) about 7 to about 9.

In an aspect of the present invention, the ceramic slurry 20 may have a viscosity of about 9.5 centipoise (cP) to about 50 cP, specifically about 25 cP to about 45 cP. When the ceramic slurry 20 has the above-ranged viscosity, the catalyst carrier for purification of exhaust gas may have a lamellar structure having the desirable pore shape and porosity.

In addition, by further adding a binder and/or a dispersing agent, the ceramic coating layer may be well adhered to the substrate 10, which may be a carrier substrate. The binder may be, for example, polyvinyl alcohol (PVA), polyvinylpyrrolidone (PVP), polyurethane (PU), polyetherurethane, polyurethane copolymer, cellulose acetate, cellulose acetate propionate, cellulose acetate butylate, polymethylmethacrylate (PMMA), polymethylacrylate (PMA), a polyacryl copolymer, polyvinylacetate (PVAc), a polyvinylacetate copolymer, polyfurfuryl alcohol (PPFA), polystyrene (PS), a polystyrene copolymer, polyethylene oxide (PEO), polypropylene oxide (PPO), a polyethylene oxide copolymer, a polypropylene oxide copolymer, polycarbonate (PC), polyvinylchloride (PVC), polycaprolactone (PCL), polyvinylidene fluoride (PVDF), a polyvinylidene fluoride copolymer, and a polyamide, and the dispersing agent may be, for example, polyacrylic acid, polymethacrylic acid, pyrophosphoric acid, citric acid, polymalic acid, ammonium polymethacrylate, benzoic acid, catechol, pyrogallol, and the like.

The binder is used to improve the adherence for the ceramic coating layer onto the ceramic-slurry-coated carrier substrate 30 and the dispersing agent is used to entirely well-disperse these binder particles.

The removing of the excess ceramic slurry may be performed by air knifing or vacuum suction, and the air knifing or the vacuum suction may be performed with pressure of about 20 kilograms square centimeter (kg/cm²) to about 50 kg/cm². When the air knifing or the vacuum suction has pressure of less than about 20 kg/cm², the slurry layer remaining in the ceramic-slurry-coated carrier substrate 30 is too thick to control the structure; on the other hand, when the air knifing or the vacuum suction pressure is more than about 50 kg/cm², all the slurry coating layer is removed, or the solvent is evaporated to be inadequately crystallized.

The freezing of the ceramic slurry coating layer in one direction may be performed by directly flowing liquid nitrogen 40 onto the ceramic-slurry-coated carrier substrate 30 in a direction of flow of exhaust gas, or positioning the carrier substrate vertically on a cooling substrate to be frozen by liquid nitrogen 40.

The liquid nitrogen 40 may provide a temperature gradient 50 of about −100 degrees Celsius (° C.) to about −20 ° C., preferably about −90 ° C. to about −40 ° C., and the solvent is frozen according to the method to induce the directional cooling crystallization. When the temperature gradient 50 is provided in a direction of flow of exhaust gas, solvent crystals 60 having directionality may be obtained. In other words, the solvent crystals 60 positioned where they are frozen in an early stage are formed relatively thin within the slurry, and the solvent crystals positioned where they are frozen in a later stage are formed relatively thick within the slurry, so the solvent crystals 60 are gradually widely formed from the early frozen region to the later frozen region. Thus, the structure capable of activating the reactivity between the material and the catalyst may be obtained.

The obtained solvent crystals 60 may be removed by lyophilization or etching. The lyophilization uses a freezing dryer to remove the solvent crystals 60 by using the principal of subliming a solvent. The etching uses a solubility difference for a certain solvent, for example, the etching selectively removes only the solvent crystals 60 by immersing them in a suitable solvent capable of dissolving the solvent crystals 60 and not dissolving the ceramic particles.

Lastly, the heat treatment such as firing may be performed in order to remove impurities such as a polymer remaining in the catalyst carrier for purification of exhaust gas and to provide a denser final structure of the catalyst carrier for purification of exhaust gas. The heat treatment may be performed at a temperature of about 550° C. to about 1600° C. for about 2 to about 4 hours.

As shown above, the method of preparing a catalyst carrier for purification of exhaust gas may include the directional cooling crystallization, so as to control the cooling temperature, the concentration and/or viscosity of the slurry, and the binder content. Thereby, the pore shape and the porosity of the ceramic coating layer may be controlled. This is the characteristic factor of the present invention that may not have been accomplished by the conventional simple evaporation.

Hereinafter, the exemplary embodiments are illustrated in more detail with reference to examples. However, these examples are exemplary, and the present disclosure is not limited thereto.

### (Preparation of Catalyst Carrier for Purification of Exhaust Gas)

### EXAMPLE 1

5 wt % of polyvinyl alcohol (PVA, average molecular weight: 124,000-186,000 (g/mol), Sigma Aldrich Korea) based on the weight of alumina particles (Al₂O₃, powder particles having an average particle diameter of 1 Kyung Do Fine Chemicals Co., Ltd.) was agitated at about 50° C. for about 24 hours and dissolved in distilled water, and 25 wt % of alumina particles was added into the solution and dispersed using a probe sonicator. The probe-sonicator has the following conditions. Under a 30% amplitude condition of the probe-sonicator having output of 750 watts at 20 kHz, ultrasonic wave grinding was performed for a total of 10 minutes (with intervals of 10 seconds (s) of work+10 s of rest).

After immersing a carrier substrate 10 having a porous honeycomb structure into an alumina slurry for about 1 minute then removing the same, the ceramic slurry coated carrier substrate 30 was treated with air knifing at an intensity of about 30 kg/cm² for about 30 seconds to remove excess slurry and then cooling-crystallized by positioning the same on a silicon wafer (Si-wafer, diameter (d)=4 inches (10.16 cm), thickness=500 μm) cooling substrate and frozen using liquid nitrogen to induce a temperature gradient 50 in a direction perpendicular to the cooling substrate.

The material solidified by cooling-crystallizing the alumina slurry coated on the carrier substrate having the porous honeycomb structure was lyophilized (freezing dryer: FDU-2200, EYELA, Tokyo, Japan, trap chilling temperature: −80 ° C., at less than or equal to about 5 Pascals (Pa)) to remove the solvent crystals 60, and thereby an alumina coating layer having a lamellar structure arranged in the exhaust gas flow direction was obtained.

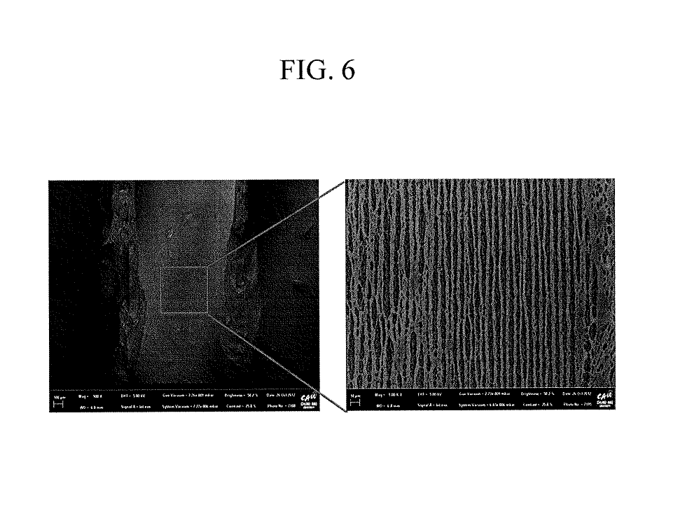

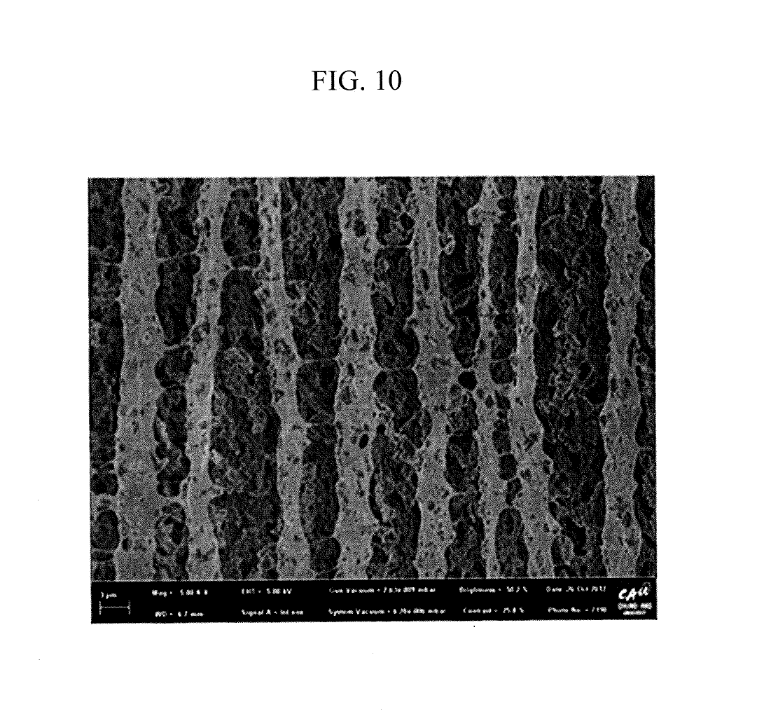

The carrier substrate having the porous honeycomb structure was provided with a dummy carrier (from Hyundai Motor Company) and cut to a size of greater than or equal to 1×2 cm. FIG. 6 and FIG. 10 show the surface of the alumina coating layer obtained from Example 1.

### EXAMPLE 2

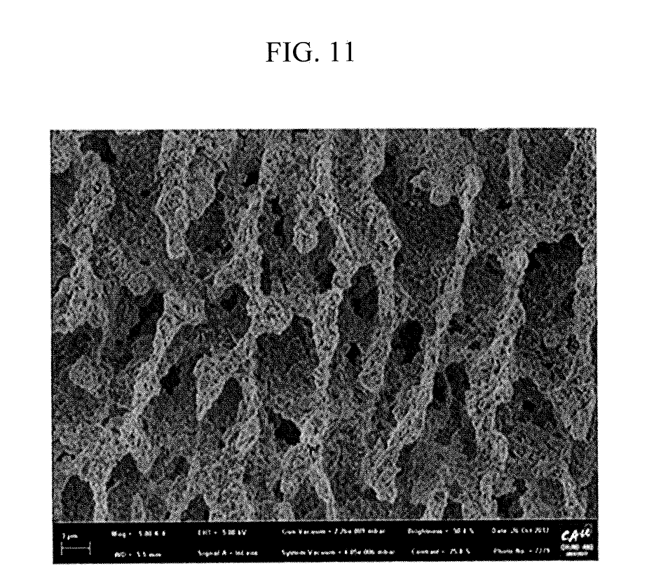

A catalyst carrier for purification of exhaust gas was prepared in accordance with the same procedure as in Example 1, except that the alumina particles were used at 30 wt % instead of 25 wt %. FIG. 11 shows the surface of the alumina coating layer obtained from Example 2.

### EXAMPLE 3

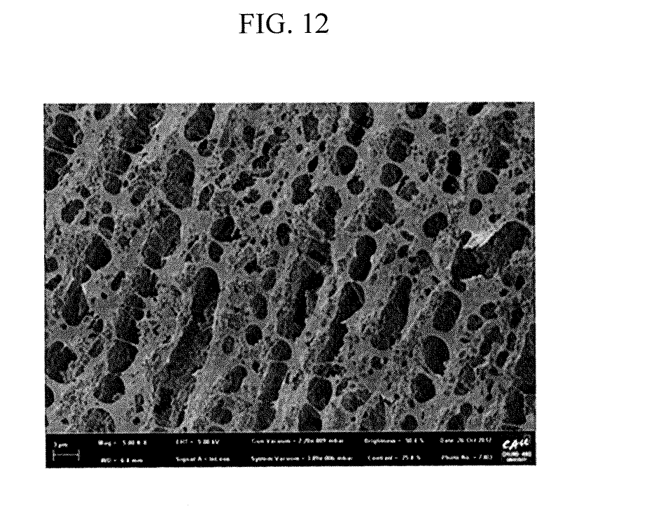

A catalyst carrier for purification of exhaust gas was prepared in accordance with the same procedure as in Example 1, except that the alumina particles were used at 35 wt % instead of 25 wt %. FIG. 12 shows the surface of the alumina coating layer obtained from Example 3.

### EXAMPLE 4

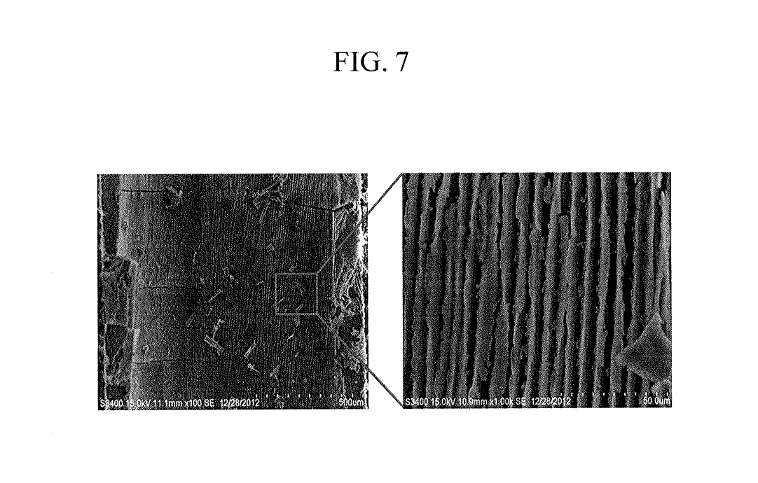

A catalyst carrier for purification of exhaust gas was prepared in accordance with the same procedure as in Example 1, except that 25 wt % of Si—Al₂O₃ (from Hyundai Motor Company) instead of alumina, 2 wt % (based on total weight of Si—Al₂O₃) of polyvinyl alcohol instead of 5 wt % of polyvinyl alcohol, and 3 wt % (based on the total weight of Si—Al₂O₃) of a dispersing agent of a Darvan C-N solution (25 wt % of ammonium polymethacrylate solution, water based) were used and dispersed by ball milling for 6 hours while preparing the ceramic slurry. FIG. 7 shows the surface of the Si—Al₂O₃ coating layer obtained from Example 4.

### EXAMPLE 5

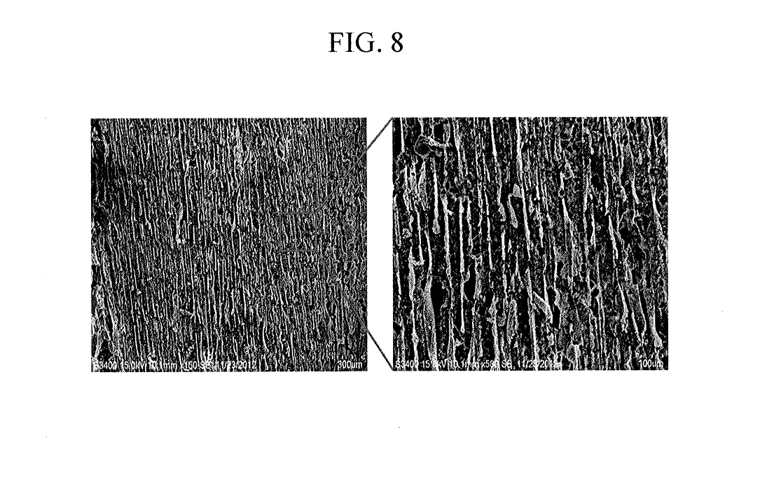

A catalyst carrier for purification of exhaust gas was prepared in accordance with the same procedure as in Example 1, except that the ceramic slurry coated carrier substrate 30 was directly cooled with liquid nitrogen 40 to be cooling-crystallized instead of positioning it on a silicon wafer (Si-wafer, d=4 inches (10.16 cm), thickness=500 μm) cooling substrate to be frozen by liquid nitrogen 40 to induce a temperature gradient 50 in a vertical direction to the substrate, and the solvent crystals 60 were removed by etching with methanol (immersed in methanol at less than or equal to −20° C. for 12 hours and removing and then drying for one day) instead of lyophilizing to remove the solvent crystals. FIG. 8 confirms the surface of the alumina coating layer obtained from Example 5.

### EXAMPLE 6

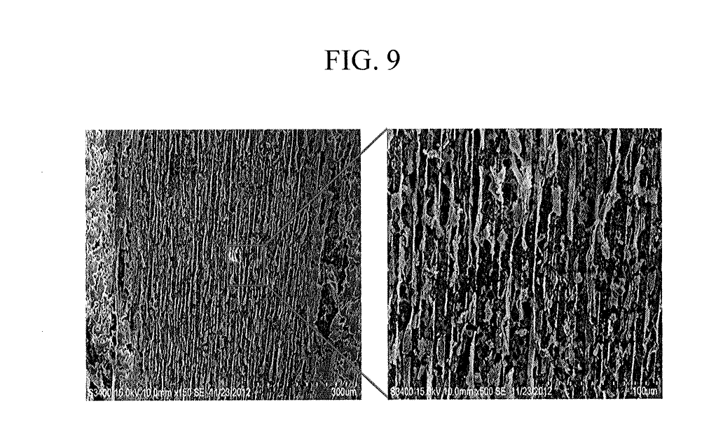

A catalyst carrier for purification of exhaust gas was prepared in accordance with the same procedure as in Example 5, except that the solvent crystals 60 were removed by etching with acetone (immersed in acetone at less than or equal to −20° C. for 12 hours and removing and then drying the same at room temperature for one day) instead of the lyophilization. FIG. 9 shows the surface of the alumina coating layer obtained from Example 6.

### COMPARATIVE EXAMPLE 1

A catalyst carrier for purification of exhaust gas was prepared in accordance with the same procedure as in Example 1, except not including the cooling crystallization.

### EVALUATION EXAMPLES

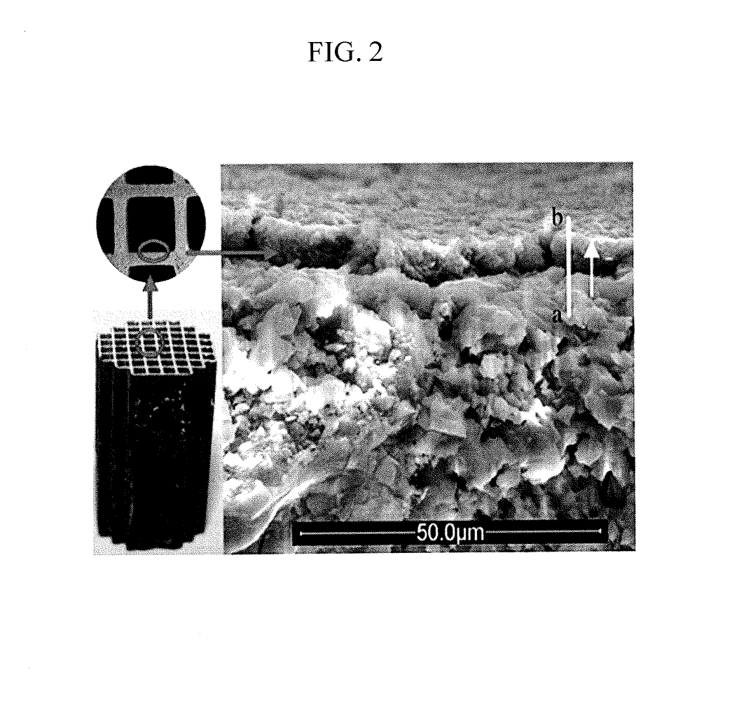

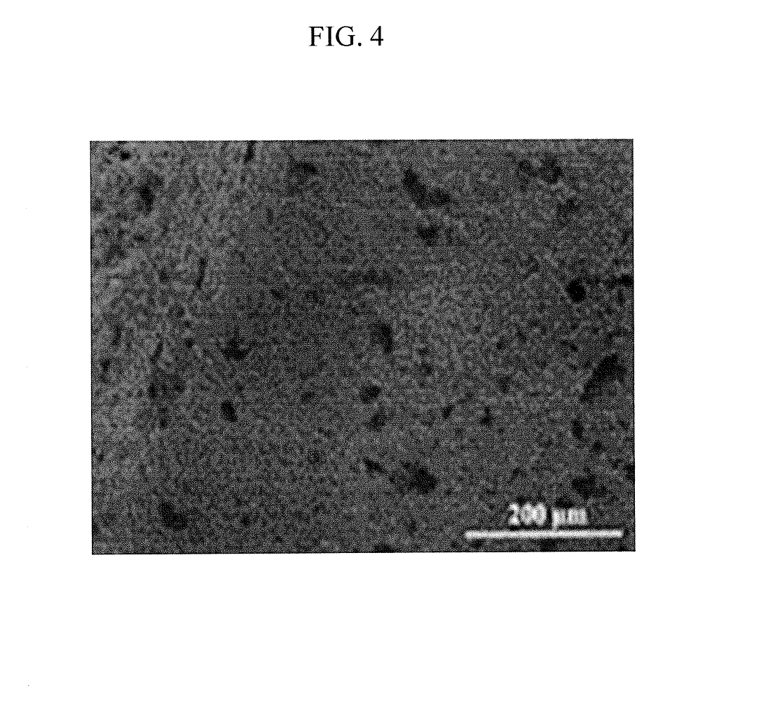

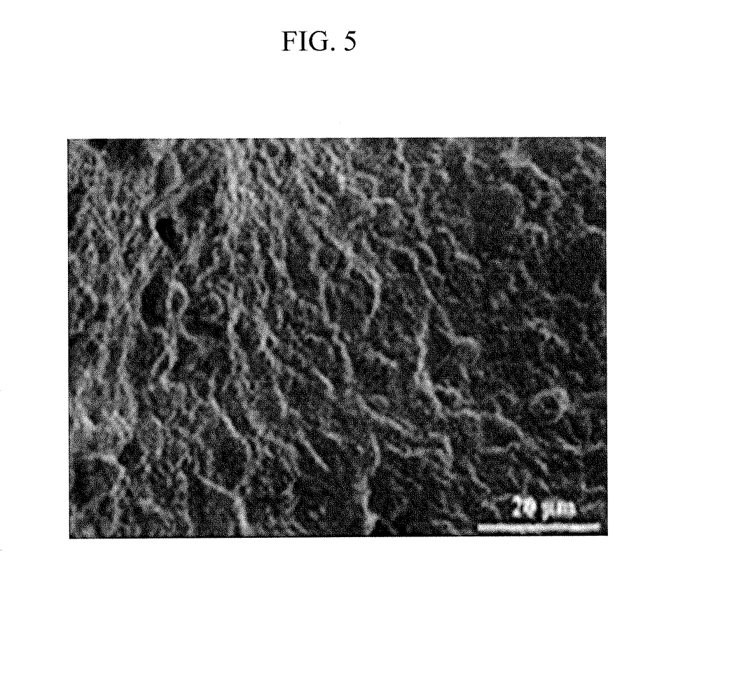

The ceramic coating layers positioned on the inside surfaces of the cell paths of catalyst carriers for purification of exhaust gas obtained from Examples 1 to 5 and Comparative Example 1 were observed with regard to the surface state with a field emission scanning electron microscope (FESEM, S-4700, Hitachi, Tokyo, Japan), and the results are shown in FIG. 2 to FIG. 11.

FIG. 2 is a scanning electron microscope photograph showing the cross-sectional surface of the catalyst carrier for purification of exhaust gas obtained by the conventional preparation method.

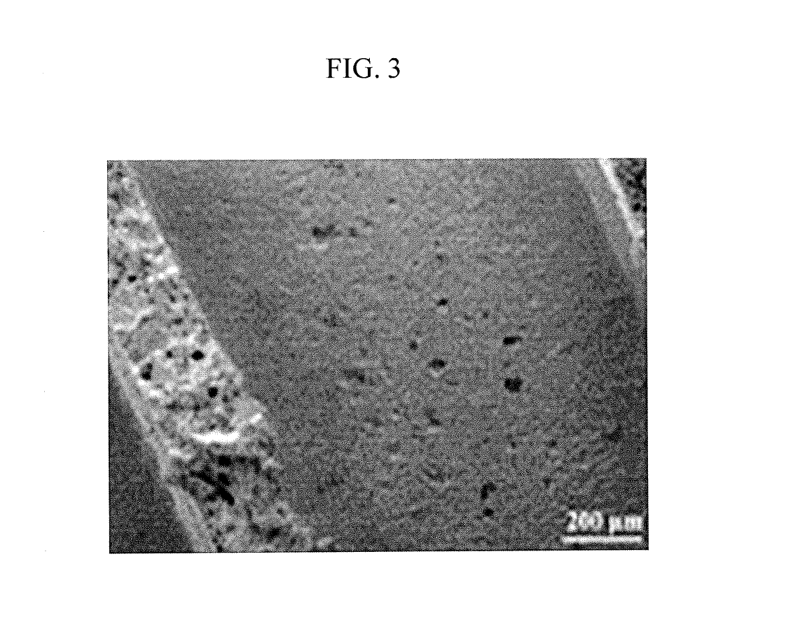

FIGS. 3 to 5 are scanning electron microscope photographs showing the surface of the coating layer of the catalyst carrier for purification of exhaust gas shown in FIG. 2.

FIGS. 6 to 9 are scanning electron microscope photographs showing the surface of the coating layer of the catalyst carrier for purification of exhaust gas according to an exemplary embodiment of the present invention.

As shown in FIGS. 6 to 9, it is confirmed that the ceramic coating layer was positioned in the lamellar structure arranged in an exhaust gas flowing direction. That is, the coating layer of the catalyst carrier for purification of exhaust gas according to an exemplary embodiment of the present invention includes lamellar-shaped pores arranged in an exhaust gas flow direction, and the wall thickness between pores was also maintained at a predetermined interval, so it was understood that the catalyst carrier for purification of exhaust gas had a structure that improves catalyst activity compared to the conventional catalyst carrier for purification of exhaust gas.

FIGS. 10 to 12 are scanning electron microscope photographs showing the surface of the coating layer of the catalyst carrier for purification of exhaust gas corresponding to the slurry concentration according to an exemplary embodiment of the present invention.

As shown in FIGS. 10 to 12, it is confirmed that the wall thickness between pores was thickened and the pore shape was changed according to the slurry concentration. Thereby, it is understood that the ceramic coating layer suitable for a catalyst activity may be provided by adjusting the composition of ceramic slurry used in the coating layer.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A catalyst carrier for purification of exhaust gas, comprising:
a substrate including a plurality of cell paths partitioned by a cell barrier rib; and
a ceramic coating layer positioned on an inside surface of the cell paths, wherein the ceramic coating layer includes a porous lamellar structure arranged in an exhaust gas flow direction.

2. The catalyst carrier for purification of the exhaust gas of claim 1, wherein the ceramic coating layer has an average pore length of approximately 2 μm to approximately 25 μm in a short axis.

3. The catalyst carrier for purification of the exhaust gas of claim 1, wherein the ceramic coating layer has an average pore length of approximately 0.1 mm to approximately 20 mm in a long axis.

4. The catalyst carrier for purification of the exhaust gas of claim 1, wherein the ceramic coating layer has an average wall thickness between pores of approximately 0.5 μm to approximately 20 μm.

5. The catalyst carrier for purification of the exhaust gas of claim 1, wherein the ceramic coating layer comprises alumina, silica, titania, zirconia, silica-alumina, alumina-zirconia, alumina-titania, silica-titania, silica-zirconia, titania-zirconia, or a combination thereof.

6. The catalyst carrier for purification of the exhaust gas of claim 1, wherein the substrate comprises cordierite, mordenite, mullite, α-alumina, β-alumina, γ-alumina, aluminosilicate, spinel, magnesium silicate, titania, zirconia, ceria, silica, an iron-chromium alloy, stainless steel, or a combination thereof.

7. A method of preparing a catalyst carrier for purification of exhaust gas, comprising:
preparing a substrate including a plurality of cell paths partitioned by a cell barrier rib and a ceramic slurry;
immersing the substrate into the ceramic slurry to coat the substrate with the ceramic slurry;
removing excess ceramic slurry;
freezing the ceramic slurry coating layer formed on the substrate in one direction by providing a temperature gradient in a vertical direction to the substrate;
removing solvent crystals from the ceramic slurry coating layer frozen in one direction; and
heat-treating the ceramic slurry coating layer.

8. The method of claim 7, wherein the substrate comprises cordierite, mordenite, mullite, α-alumina, β-alumina, γ-alumina, aluminosilicate, spinel, magnesium silicate, titania, zirconia, ceria, silica, iron-chromium alloy, stainless steel, or a combination thereof.

9. The method of claim 7, wherein the ceramic slurry comprises alumina, silica, titania, zirconia, silica-alumina, alumina-zirconia, alumina-titania, silica-titania, silica-zirconia, titania-zirconia, or a combination thereof.

10. The method of claim 7, wherein an amount of ceramic in the ceramic slurry is approximately 1 wt % to approximately 40 wt % based on a total weight of the ceramic slurry.

11. The method of claim 7, wherein an amount of ceramic in the ceramic slurry is approximately 10 wt % to approximately 35 wt % based on the total weight of the ceramic slurry.

12. The method of claim 7, wherein the ceramic slurry has viscosity of approximately 9.5 cP to approximately 50 cP.

13. The method of claim 7, wherein the ceramic slurry has viscosity of approximately 25 cP to approximately 45 cP.

14. The method of claim 7, wherein the removing of the excess ceramic slurry is performed by air knifing or vacuum suction, and the air knifing or the vacuum suction is performed with a pressure of approximately 20 kg/cm² to approximately 50 kg/cm².

15. The method of claim 7, wherein the freezing of the ceramic slurry coating layer in one direction is performed by directly flowing liquid nitrogen onto the substrate in a direction of flow of the exhaust gas, or positioning the substrate vertically on a cooling substrate to be frozen by the liquid nitrogen.

16. The method of claim 7, wherein the temperature gradient is provided in a range from approximately −100° C. to approximately −20° C.

17. The method of claim 7, wherein the preparing of the ceramic slurry further comprises adding an additive selected from a binder, a dispersing agent, an acid solution, or a combination thereof.

18. The method of claim 17, wherein the additive is mixed at approximately 0.1 parts to approximately 10 parts by weight based on 100 parts by weight of ceramic in the ceramic slurry.

19. The method of claim 7, wherein the removing of the solvent crystals is performed by lyophilization or etching.

20. A catalyst for purification of the exhaust gas comprising the catalyst carrier for purification of the exhaust gas of claim 1 and a catalyst.
